(19) United States
(12) Patent Application Publication
(10) Pub. No.: US 2008/0095558 A1
(43) Pub. Date: Apr. 24, 2008

(54) Method for Uv Curing Toner Images Applied to an Image Support in an Electrographic Printing or Copying Device

(76) Inventor: Martin Schleusener, Namborn (DE)

Correspondence Address: SCHIFF HARDIN, LLP;PATENT DEPARTMENT, 6600 SEARS TOWER, CHICAGO, IL, 60606-6473, US

(21) Appl. No.: 11/574,284

(22) PCT Filed: Sep. 9, 2005
(86) PCT No.: PCT/EP05/09723

§ 371 Date: Feb. 26, 2007

(30) Foreign Application Priority Data
Sep. 10, 2004 (DE) 10 2004 043 920.6

(51) Int. Cl. G03G 13/20

(52) U.S. Cl. 399/336

(57) ABSTRACT

In a method and system for modification of at least one property of toner images applied on an image carrier in the electrographic printing and copying device, a toner material is used comprising UV-curable components for a generation of the toner images. The toner images on the image carrier are subjected to an IR exposure with at least one IR component in order to generate a heat recorder for polymerization, and to a UV exposure with UV components.

### BACKGROUND

For single- or multi-colored printing of a final image carrier, for example of a single sheet or of a belt-shaped recording medium made up of the most varied materials (for example paper or thin plastic or metal films), it is known to generate image-dependent potential images (charge images) on a potential image carrier (for example a photoconductor), which potential images correspond to images to be printed that comprise regions to be inked and regions that are not to be inked. The regions of the potential images that are to be inked are made visible as toner images with a developer station (inking station) via toner. The toner images are subsequently transfer-printed onto the final image carrier directly or under interposition of an intermediate image carrier and are fixed on the final image carrier.

Either dry toner or liquid developer comprising toner can thereby be used for inking of the potential images.

The toner images applied and affixed on the final image carrier (called final images hereafter) should exhibit wear resistance, be temperature-resistant and their glossiness should correspond to the posed requirements. An agglutination of oppositely-situated final images (blocking) should additionally not happen.

Dry toner layers can be smoothed under pressure in a conventional manner during or after the fixing process, for example by means of cold or heated rollers, whereby the gloss can be increased and the tendency towards mechanical wear can be reduced.

From DE 100 64 560 A1 or DE 100 64 552 A1 it is known to fix toner images and to provide them with gloss in electrographic printers in that the toner image is melted by infrared light and then is cured via UV exposure, whereby the viscosity increases. For this a toner is used that comprises at least one polymer.

U.S. Pat. No. 5,888,689 describes a method in which toner images on a carrier are fixed onto the carrier via chemical reaction of the toner with a layer on the carrier. The fixing is supported by heating (for example infrared exposure); and the toner image can additionally be cured via UV exposure.

UV-curable toner particles and the developer comprising these are described in EP 1 437 628 A1. The toner images are fixed via heat (IR exposure) and cured via UV exposure.

DE 694 26 920 T2 discloses toner for development of electrostatic toner images in which a polyester resin is used as a binding resin, and in fact a combination of a non-linear polyester resin and a linear polyester resin. The polyester resins can accordingly be subjected to a cross-linking reaction.

US 2002/0118986 describes a printer in which the fixing of toner images occurs via exposure in the range of UV to IR wavelengths. A radiation source is proposed for this.

An image recording method in which the toner images are melted and fixed via electromagnetic radiation results from DE 101 35 865 B4. The wavelength of the radiation lies in the range from 0.8 μm to 10 μm, advantageously 0.8 to 3 μm.

The fixing of toner images occurs with electromagnetic radiation in DE 100 64 563 A1. Given multi-colored printing the colors are arranged one atop the other and the waveband is selected corresponding to the color. A waveband from 420 to 460 nm is selected for yellow toner, 510 to 550 nm is selected for magenta, 630-670 nm is selected for cyan. The color toner images arranged atop one another can be separately fixed in this manner.

DE 100 64 577 A1 describes a method for controlling the gloss of a toner image. The toner image is fixed via heating and subsequently heated again (in the UV range) corresponding to the desired toner image gloss.

A method according to which toner images are first fixed (via typical methods) and subsequently cured with UV radiation results from EP 1 341 048 A1.

US 2003/01655766 A1 illustrates an electrophotographic printer in which the toner images are initially fixed and subsequently cured. Fixing is by cross-linking, and curing by polymerization via UV or IR radiation. The UV radiation lies in the range from 200 nm to 250 nm.

### SUMMARY

It is an object to specify a method with which the properties of toner images (such as, for example, their wear resistance, temperature resistance, gloss and viscosity) on an image carrier can be adjustably modified.

In a method and system for modification of at least one property of toner images applied on an image carrier in the electrographic printing and copying device, a toner material is used comprising UV-curable components for a generation of the toner images. The toner images on the image carrier are subjected to an IR exposure with at least one IR component in order to generate a heat recorder for polymerization, and to a UV exposure with UV components.

### BRIEF DESCRIPTION OF THE DRAWINGS

FIG. 1 is a principle representation of a printing or copying device with which the method can be implemented; and

FIG. 2 shows the treatment of a final image in principle representation.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

The preferred embodiment solves the problem posed above via UV-IR exposure of the toner images on the image carrier, for example an intermediate image carrier or a final image carrier, whereby a toner material is selected that comprises UV-curable components. These can, for example, comprise linear or branched polyester resins or other resins that are not yet very significantly three-dimensionally cross-linked or are otherwise suitable for UV curing. The intensity of the photopolymerization in the toner material that is achieved via UV exposure can be amplified via the addition of photoinitiators.

The method can advantageously be used in order to adapt final images already fixed on the final image carrier (recording medium) to the required properties of the print good or to the special exposure conditions of specific print post-processing or shipping conditions, which adaptation corresponds to the specific requirements. Furthermore, the method can be used in order to ease or to enable the transfer process of toner images from an image carrier onto a final image carrier, in particular a thick final image carrier.

The method can be advantageously used both when dry toner and when liquid developer are used for development of the potential images.

According to the preferred embodiment, the chemical properties of the toner material and the spectral distribution and power density of the exposure are tuned to one another. The procedure of the UV curing is thereby optimized via the correct spectral distribution and the correct power density of the radiation.

A radiation source can normally be used that radiates a combination of ultraviolet light (wavelength: 200 to 400 nm, abbreviation characters: UV), visible light (wavelength: 400 to 700 nm, abbreviation characters: VIS) and infrared heat radiation (wavelength: 700 nm to 10 μm, abbreviation characters: IR). The relative proportion of these spectral ranges is thereby selected such that (in adaptation to the chemical composition of the photopolymerizable toner material) the IR/VIS components are used for the activation of the bonds necessary for photopolymerization (heating) and the UV component is used for actual curing of the photopolymerizable toner material. Both the relative proportions of the spectral ranges as well as the absolute power density of the radiation must be adapted to the chemical properties of the corresponding materials, to the thickness of the slice to be polymerized and to the process speed of the printing and fixing process or of the post-processing process. Moreover, an additional or stronger heating of the toner material can be generated via a sufficiently strong IR exposure (which advantageously comprises high proportions in the frequency range of the primary absorption of the toner material used), which stronger heating in turn effects a better bonding of the toner particles to one another and to the image carrier and possibly effects a higher gloss of the surface.

The following techniques are advantageous in order to effect a fine gradation of the curing process, an influencing of the gloss and of the wear resistance, for example of the final image on a final image carrier and of the adhesion effect at increased temperatures:
The fixing quality, the gloss and the wear resistance of the final image and/or of the adhesion effect at high temperatures are, via targeted usage of specific UV wavelength ranges, adapted corresponding to the desired properties of the final image and to the exposure of the final image that is to be expected in a specific post-processing line.
The UV-A radiation (wavelength: 320 to 400 nm) has a greater penetration depth and effects a stronger volume effect, i.e. a polymerization of the entire layer volume of the final image.
As a consequence of lower penetration depth, the UV-B radiation (wavelength: 280 to 320 nm) effects a stronger curing of the material on the surface than inside the final image carrier.
The UV-C radiation (wavelength: 200 to 280 nm) is used for surface curing.
The use of inert gas (for example nitrogen) leads to amplified surface curing of the final image or to a lower proportion of photoinitiators in the toner resin.
A corona exposure before and/or during the UV curing leads to reduced surface polymerization of the final image carrier, which can, for example, be used to prevent a too-severe brittleness of the surface and to better elasticity in the post-processing.
A good liquefaction or adhesion of the toner image as well as a good connection of the toner image with the surface of the final image carrier given high surface gloss can be achieved via the suitable combination of corona action and stronger IR exposure before the UV curing. This can in particular be required given poorly-adhering final image carriers such as papers that are not well-compatible with the toner as well as smooth polymer films or metal films. If a particularly hard surface is desired, post-curing can occur with UV-C.
Pure surface curing with UV-C is appropriate when the elasticity of the toner image should be retained (good buckling resistance).

The described UV curing processes can also be used for complete through-fixing of toner images that were only “fixed on” in the actual fixing process.

The method of the preferred embodiment additionally brings further advantages given the intervening curing or viscosity increase or transfer onto very thick final image carriers:
In the variants described above, given the use of reduced exposure power the UV exposure can also be used to increase the viscosity of the heated toner image in arbitrary stages of the printing process.
For example, to support the transfer printing of the toner image onto a very thick final image carrier in which an electrostatic transfer-printed support also runs into difficulties, the viscosity of the toner image can be increased in the heated state such that the entire toner layer can be cohesively transferred from an intermediate image carrier with low surface energy (for example Teflon) onto the thick final image carrier (for example thick cardboard, wood or the like) via contact pressure.
Such a process can be optimized in that a corona pre-treatment in combination with UV-A curing is used, whereby a toner image film with adhesive surface (which toner image film is cohesive in volume) is generated which leads to a complete transfer of the toner image with adhesive effect onto the final image carrier.
A UV-A/B post-curing leads to sufficient adhesion and stability of the toner image on the final image carrier.
Among other things, the MICR toner wear resistance can also be increased, whereby the basic elasticity of the toner image (good buckling resistance) is retained in that an IR exposure and a UV-C exposure are successively or simultaneously implemented.

Given multi-colored printing the various color image separations can be successively generated on the potential image carrier and successively transferred either onto an intermediate image carrier or onto the final image carrier. The color image separations can also be collected directly on the potential image carrier and then be transferred together onto the final image carrier, or they can be individually transferred from the potential image carrier onto the intermediate image carrier, be collected on this, and then be transferred onto the final image carrier.

Given this use case of the method a curing of the total image (comprising a plurality of color separations) can be implemented via adapted UV-IR exposure.

It is also possible to generate individual color separations with particular gloss or wear properties in order to emphasize them in terms of appearance or make them better in terms of differentiability, in that these color separations are subjected to a separate treatment with a series of IR exposure, UV exposure and/or a corona pre-treatment.

For example, an image curing with retention of the matte properties can be achieved in that a UV-C exposure occurs first, then a combined IR-UV-A exposure. An increased gloss can be achieved in that a corona treatment of the toner surface occurs first, then an IR exposure or simultaneous corona treatment with UV exposure, which causes a sufficient softening with gloss increase (up to the liquefaction of the toner image), after which a UV exposure is implemented. After a softening via IR exposure or via contact with a hot roller or belt surface, a smooth or intended matte surface with increased stability and hardness can be achieved via roller stamping with specific surface roughness and subsequent UV exposure.

Furthermore, print image elements can furthermore be generated that can be scratched off easily. A final image or a part of a final image can be embrittled via a particularly strong UV exposure, advantageously without or with low IR exposure, which leads, for example, to a markedly reduced scratch resistance.

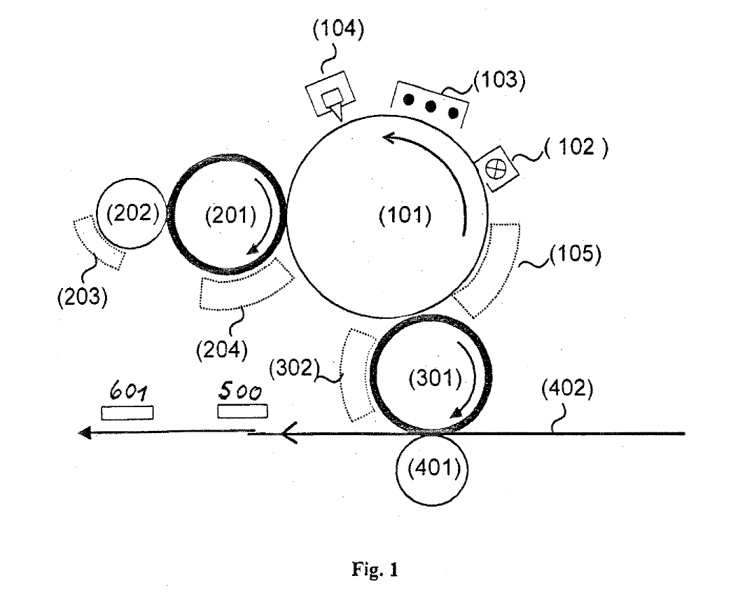

A principle representation of an electrographic printing device arises from FIG. 1. A potential image carrier 101 (for example a photoconductor drum) is exposed to an erasure exposure 102 The charging of the potential image carrier subsequently occurs in the station 103. Potential images of images to be printed are generated on the potential image carrier 101 via exposure according to the image in the station 104. These potential images are developed in a developer station via toner material, for example in a liquid developer. For this, for example, liquid developer is extracted from a developer reservoir 203 and supplied to an applicator roller 201 via an application roller 202. The applicator roller 201 conveys the liquid developer to the potential image carrier 101. The applicator roller 201 is subsequently cleaned in the cleaning station 204.

Given the development of the potential images on the potential image carrier 101, toner migrates into the regions to be inked on the potential image carrier 101 and accumulates there; nearly no toner migrates into the regions that are not to be inked at the potential image carrier 101. The toner image thus forms on the potential image carrier 101. The toner image is transferred onto a final image carrier 402 in a transfer printing station via an intermediate image carrier 301. A counter-pressure roller 401 is used for this.

The final image carrier 402 is finally supplied to a fixing station 500; the fixing can occur in a known manner.

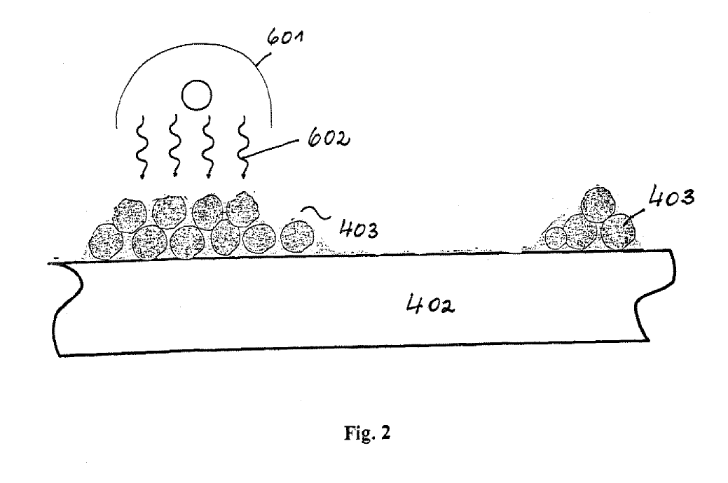

The treatment of the final image 403 on the final image carrier 402 results in principle from FIG. 2 corresponding to the method illustrated above. For this a radiation source 601 is provided that emits the radiation 602 described above. The radiation 602 is directed onto the final image carrier 402 and there strikes the final image 403. Via the radiation 602 the final image 403 is alternately cured or provided with gloss corresponding to the method illustrated above.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

I claim as my invention:

1-33. (canceled)

34. A method for modification of at least one property of toner images applied on an image carrier in an electrographic printing or copying device, comprising the steps of:
using a toner material comprising UV-curable components for generation of the toner images; and
subjecting the toner images on the image carrier independently of a fixing of the toner images to an IR exposure with at least one IR component in order to generate a heat required for polymerization, and to a UV exposure with UV components whose wavelength is set
in a range from 320 to 400 nm (UV-A) when a polymerization of substantially an entire layer volume of the toner images is to be achieved,
in a range from 280 to 320 nm (UV-B) when a stronger curing of the toner images is to be achieved substantially on their surface compared to inside them, and
in a range from 200 to 280 nm (UV-C) when the toner images are to only be cured substantially on their surface.

35. A method according to claim 34 in which an intermediate image carrier or a final image carrier on which the toner images are affixed as final images is used as the image carrier.

36. A method according to claim 34 in which the image carrier is subjected to a corona exposure at least one of before or after the UV exposure.

37. A method according to claim 36 in which at least one of a corona exposure or the IR exposure is used before the UV exposure when a good adhesion of the toner images as well as a good bonding of the toner images with a surface of the image carrier given high surface gloss is intended.

38. A method according to claim 36 in which at least one of a corona exposure or the IR exposure is used before transfer printing of the toner images from an intermediate image carrier onto a final image carrier and the UV exposure occurs after the transfer printing of heated toner images onto the final image carrier.

39. A method according to claim 34 in which the UV exposure is used to increase a viscosity of the toner image such that a transfer printing of the toner images onto an intermediate image carrier can occur via contact pressure.

40. A method according to claim 39 in which, to support the transfer printing of the toner images onto the final image carrier, their viscosity is increased such that an entire toner layer is transferred from an intermediate image carrier with low surface energy onto a thick final image carrier.

41. A method according to claim 39 in which the toner images are subjected to a corona pre-treatment in combination with a UV-A curing, such that a toner film with an adhesive surface is generated and a complete transfer of the toner film with adhesion onto a final image carrier is possible.

42. A method according to claim 34 in which an effect of the UV exposure is optimized via adjustment of proportions of spectral ranges and power densities.

43. A method according to claim 34 in which the IR exposure comprises proportions in a frequency range of a primary absorption of the toner material used.

44. A method according to claim 34 in which post-curing is implemented with the UV-C exposure when a particularly hard surface of the toner images is intended.

45. A method according to claim 35 in which the final images on the final image carrier is subjected to a UV-A/B post-curing.

46. A method according to claim 35 in which a wear resistance of the final images is increased without changing a basic elasticity o the final images in that the IR exposure and the UV-C exposure are implemented in succession or simultaneously.

47. A method according to claim 34 in which a radiation source is used for the exposures of the image carrier, the radiation source radiating a combination of ultraviolet light, visible light, and infrared heat radiation.

48. A method according to claim 47 in which the radiation is adjusted such that a visible light and the IR radiation generate heat necessary for activation of the polymerization and the UV radiation cures of the polymerizable toner material are provided.

49. A method according to claim 35 in which color separations on a potential image carrier on the intermediate image carrier are collected and subsequently transferred as a total image onto the intermediate image carrier or final image carrier given multi-colored printing.

50. A method according to claim 49 in which a curing of the total image is implemented via the UV-IR exposures.

51. A method according to claim 49 in which individual color separations are subjected to a separate treatment with a series of at least one of the IR exposure, UV exposure, or a corona pre-treatment in order to adjust gloss or wear properties of the color separations such that an appearance of the color separations is emphasized or they can be better differentiated.

52. A method according to claim 50 in which the image curing with retention of matte properties is achieved in that the UV-C exposure occurs first, and then a combined IR-UV-A exposure.

53. A method according to claim 50 in which, to increase gloss, a corona treatment of a surface of the toner image is implemented first, then the IR exposure or a simultaneous corona treatment with the IR exposure, and then the UV exposure.

54. A method according to claim 34 in which a linear polyester resin is used as the toner material.

55. A method according to claim 34 in which a branched polyester resin is used as the toner material.

56. A method according to claim 34 in which a resin that is not significantly three-dimensionally cross-linked is used as the toner material.

57. A method according to claim 34 in which, to influence an intensity of the polymerization of the toner material, photo-initiators are added.

58. A method according to claim 57 in which an inert gas is used when an expanded surface curing or a lower proportion of photo-initiators in the toner resin is to be achieved.

59. A method according to claim 58 in which nitrogen is used as an inert gas.

60. A method according to claim 34 in which a roller stamping follows the UV exposure.

61. A method according to claim 60 in which a smooth or matte surface with increased stability and hardness is achieved after softening of the toner image via the IR exposure or via contact with a hot roller or belt surface via a roller stamping with selectable surface roughness and subsequent UV exposure.

62. A method according to claim 35 in which the final images or a portion thereof are embrittled via a strong UV exposure of the final image.

63. A method according to claim 62 in which an IR exposure of lower intensity is additionally used.

64. An electrographic printing or copying device, comprising:
a transfer printing station at which images are transfer-printed and affixed onto an image carrier;
said transfer printing station employing a toner material comprising UV-curable components for generation of the toner images;
a fixing station for fixing the toner images; and
an exposure station for modification of at least one property of the toner images, said exposure station subjecting the toner images independently of the fixing station to an exposure of at least one IR component in order to generate a heat required for polymerization, and to a UV exposure with UV components whose wavelength is set
in a range from 320 to 400 nm (UV-A) when a polymerization of substantially an entire layer volume of the toner images is to be achieved,
in a range from 280 to 320 nm (UV-B) when a stronger curing of the toner images is to be achieved on substantially their surface compared to inside them, and
in a range from 200 to 280 nm (UV-C) when the toner images are to only be cured substantially on their surface.

65. An electrographic printing or copying device according to claim 64 in which the exposure station comprises a radiation source that generates radiation used for the treatment of the final image provided after the fixing.

66. An electrographic printing or copying device of claim 64 in which the exposure station comprises a radiation source that generates radiation used for the treatment of the image and wherein said exposure station is provided after said fixing station.

67. A device according to claim 64 wherein the toner images comprise final images.

68. A device of claim 64 wherein a viscosity of the toner images on the image carrier is increased by the exposure station such that the transfer printing of the toner images onto the image carrier occurs only via contact pressure.

69. An electrographic printing or copying device, comprising:
a transfer printing station at which images are transfer-printed and affixed onto an image carrier;
said transfer printing station employing a toner material comprising UV-curable components for generation of the toner images; and
an exposure station for modification of at least one property of the toner images, said exposure station subjecting the toner images independently of a fixing of the toner images to an exposure of at least one IR component in order to generate a heat required for polymerization, and to a UV exposure with UV components whose wavelength is set
in a range from approximately 320 to 400 nm (UV-A) when a polymerization of substantially an entire layer volume of the toner images is to be achieved,
in a range from approximately 280 to 320 nm (UV-B) when a stronger curing of the toner images is to be achieved substantially on their surface compared to inside them, or
in a range from approximately 200 to 280 nm (UV-C) when the toner images are to only be cured substantially on their surface.

70. A method for modification of at least one property of toner images applied on an image carrier in an electrographic printing or copying device, comprising the steps of:
using a toner material comprising UV-curable components for generation of the toner images; and
subjecting the toner images on the image carrier independently of a fixing of the toner images to an IR exposure with at least one IR component in order to generate a heat required for polymerization, and to a UV exposure with UV components whose wavelength is set
in a range from approximately 320 to 400 nm (UV-A) when a polymerization of substantially an entire layer volume of the toner images is to be achieved,
in a range from approximately 280 to 320 nm (UV-B) when a stronger curing of the toner images is to be achieved substantially on their surface compared to inside them, or
in a range from approximately 200 to 280 nm (UV-C) when the toner images are to only be cured substantially on their surface.
